(19) United States
(12) Patent Application Publication
(10) Pub. No.: US 2016/0054606 A1
(43) Pub. Date: Feb. 25, 2016

(54) FLAT PANEL DISPLAY DEVICE

(71) Applicant: KABUSHIKI KAISHA TOSHIBA, Tokyo (JP)

(72) Inventors: Tatsuo SAISHU, Kokubunji Tokyo (JP); Yoshiharu MOMONOI, Yokohama Kanagawa (JP)

(21) Appl. No.: 14/750,379

(22) Filed: Jun. 25, 2015

Related U.S. Application Data
(60) Provisional application No. 62/040,807, filed on Aug. 22, 2014.

(51) Int. Cl. G02F 1/1333; G02F 1/1335

(52) U.S. Cl. CPC G02F 1/13336; G02F 1/133526

(57) ABSTRACT

A flat panel display device has a plurality of display panels arranged adjacent to one another on a display screen. Each display panel has an image-forming substrate having a display part and a non-display part disposed around the display part and a transparent member disposed on the image-forming substrate so as to cover the display part and the non-display part. Among the display panels, two adjacent display panels are arranged in a manner that non-display parts of the two adjacent display panels are at least partially overlapped with each other. The transparent member of each of the two adjacent display panels has a magnifying optical part to magnify an image displayed in part of a display area located in a region from a border between the display part and the non-display part toward the display part.

### CROSS REFERENCE TO RELATED APPLICATIONS

This application is based upon and claims the benefit of U.S. provisional Application No. 62/040,807, filed on Aug. 22, 2014, the entire contents of which are incorporated herein by reference.

### FIELD

Embodiments of the present invention relate to a flat panel display device.

### BACKGROUND

The trend in liquid crystal panels has been moving toward large screens. However, the upsizing of liquid crystal panels causes low yield, and hence a technique to assemble a very large display with a plurality of conventional liquid crystal panels arranged in vertical and horizontal directions has been researched.

Liquid crystal panels have a non-display part around a display screen. The non-display part is sometimes referred to as a frame. Very large displays assembled with a plurality of liquid crystal panels arranged in vertical and horizontal directions have a problem that an image is fragmented on the non-display part disposed at the border between liquid crystal panels.

A technique of arranging optical components above non-display parts of two liquid crystal panels arranged adjacent to each other has been proposed in order to make the non-display parts invisible. However, it is not technically easy to make two non-display parts aligned in a horizontal direction completely invisible. Moreover, a viewer may not always view a screen of a display from right in front of the display but may view it from an oblique direction. However, conventionally, measures for making non-display parts invisible have been insufficient in the case where a viewer views a screen from an oblique direction. Furthermore, when non-display part is wide, width and thickness of optical components may increase, and thus the optical components may avoid view quality.

### BRIEF DESCRIPTION OF THE DRAWINGS

FIG. 1 is a view including a plan view and a sectional view of each display panel 1;

FIG. 2 is an enlarged sectional view of an edge section of a display panel 1;

FIG. 3 is a sectional view illustrating a supporting method according to one modification;

FIG. 4 is a view including a plan view and a sectional view of a flat display 10 according to the present embodiment;

FIG. 5 is a view including a plan view and a sectional view of a flat display 10 according to one modification to FIG. 4;

FIG. 6 is a view including a plan view and a sectional view of a flat display 10 having three display panels 1 arranged vertically and horizontally;

FIG. 7 is a view including a plan view and a sectional view of a flat display 10 having three display panels 1 arranged adjacent to one another in a horizontal direction;

FIG. 8 is a view including a plan view and a sectional view of a flat display 10 according to one modification to FIG. 7;

FIG. 9 is a sectional view of two non-display parts 5 overlapped with each other and the area around the two non-display parts 5;

FIG. 10 is an enlarged sectional view of a flat display 10 having magnifying optical parts 11 made of a cylindrical lens instead of a linear Fresnel lens;

FIG. 11 is a view illustrating a virtual image in the case where a viewer views the flat display 10 from the direction of normal to the display screen;

FIG. 12 is a view illustrating a virtual image in the case where a viewer views the display screen from an obliquely left direction;

FIG. 13 is a view illustrating a virtual image in the case where a viewer views the display screen from an obliquely right direction;

FIG. 14 is a view showing an example using display panels 1 of the same structure, with no level difference between the surfaces of transparent members 3;

FIG. 15 is a sectional view showing an example of driver IC incorporation according to the present embodiment; and

FIG. 16 is a sectional view showing another example of driver IC incorporation according to the present embodiment.

### DETAILED DESCRIPTION

A flat panel display device according to an embodiment is provided with a plurality of display panels arranged adjacent to one another on a display screen. Each display panel has an image-forming pixels creation substrate having a display part and a non-display part disposed around the display part and a transparent member disposed on the image-forming pixels creation substrate so as to cover the display part and the non-display part. Among the display panels, two adjacent display panels are arranged in a manner that non-display parts of the two adjacent display panels are at least partially overlapped with each other. The transparent member of each of the two adjacent display panels has a magnifying optical part to magnify an image displayed in a partial display area in the display part from a border between the display part and the non-display part toward the display part.

Embodiments will now be explained with reference to the accompanying drawings. A flat panel display device (hereinafter, called a flat display) in each embodiment has a plurality of display panels arranged adjacent to one another on a display screen. The display panels have the same size and structure.

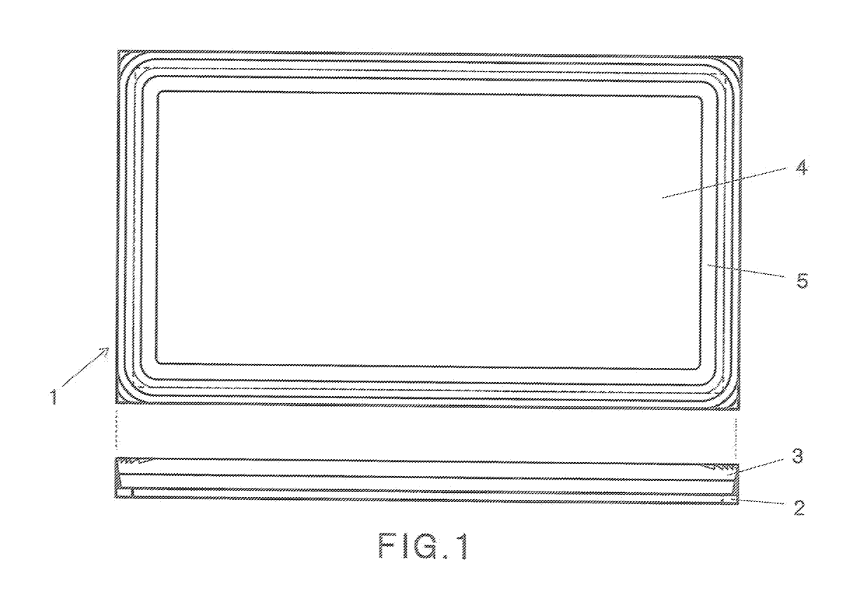

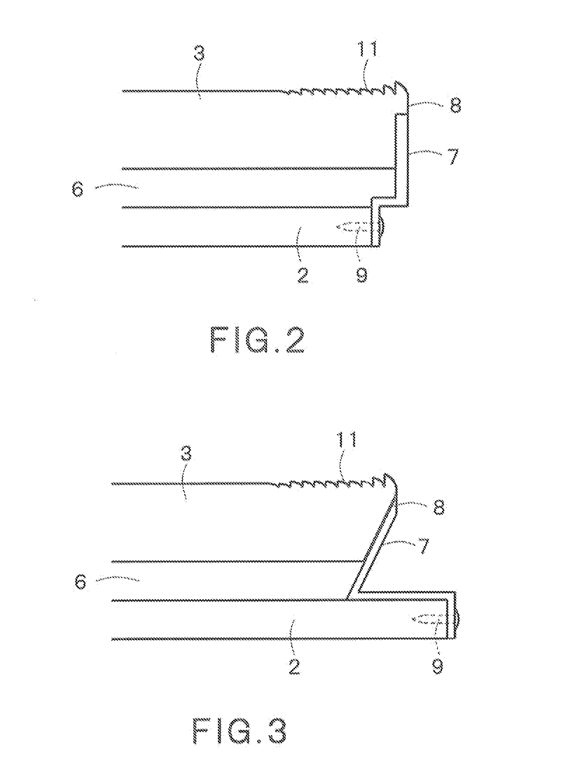

FIG. 1 is a plan view and a sectional view of each display panel 1. FIG. 2 is an enlarged sectional view of an edge section of a display panel 1.

As shown in these figures, each display panel 1 is provided with an image-forming substrate 2 and a transparent member 3 disposed in front of the image-forming substrate 2. The image-forming substrate 2 is, for example, a liquid crystal panel. To the image-forming substrate 2, a variety of flat display panels, such as an EL (ElectroLuminescent) display panel and a plasma display panel are applicable.

When the image-forming substrate 2 is a liquid crystal panel, the image-forming substrate 2 has an orientation film, a liquid crystal layer, a color filter layer, etc. sealed between two glass substrates (not shown). A backlight substrate (not shown) may be provided at the rear side of the image-forming substrate 2, according to need.

A display part 4 and a non-display part 5 disposed around the display part 4 are provided on a substrate surface (hereinafter, also referred to as a display surface) of the image-forming substrate 2. A wiring pattern connected to the display part 4 and made of a metal, ITO (Indium Tin Oxide), etc. is formed in the non-display part 5. In the case where a touch panel substrate (not shown) is provided on the display part 4 or a touch panel sensor is built in the display part 4, a wiring pattern connected to the touch panel sensor is also formed in the non-display part 5.

As shown in FIG. 2, the image-forming substrate 2 and the transparent member 3 are arranged with a space 6 therebetween. The image-forming substrate 2 and the transparent member 3 are supported by a metal plate 7 provided at the side face, for example. In the example of FIG. 2, the transparent member 3 and the metal plate 7 are fixed to each other with an adhesive 8 while the image-forming substrate 2 and the metal plate 7 are fixed to each other by a screw 9. However, a method supporting with the metal plate 7 is not limited to the shown one, as long as adjacent lenses can be in contact with each other. For example, FIG. 3 is a sectional view illustrating a supporting method according to one modification. In the case of FIG. 3, the side face of the transparent member 3 is inclined toward inside with a wedge-shaped metal plate 7 disposed along the inclined surface. The metal plate 7 and the transparent member 3 are fixed to each other, for example, with an adhesive 8. The metal plate 7 and the image-forming substrate 2 are fixed to each other by a screw 9, like shown in FIG. 2. With the structure as shown in FIG. 3, a space is secured outside the side face of the transparent member 3 and, as described later, a flexible wiring substrate or the like for driving the display panel 4 can be disposed in this space.

It is not important for the present embodiments whether to provide the space 6 between the image-forming substrate 2 and the transparent member 3, hence the space 6 will be omitted from the figures used in the following description.

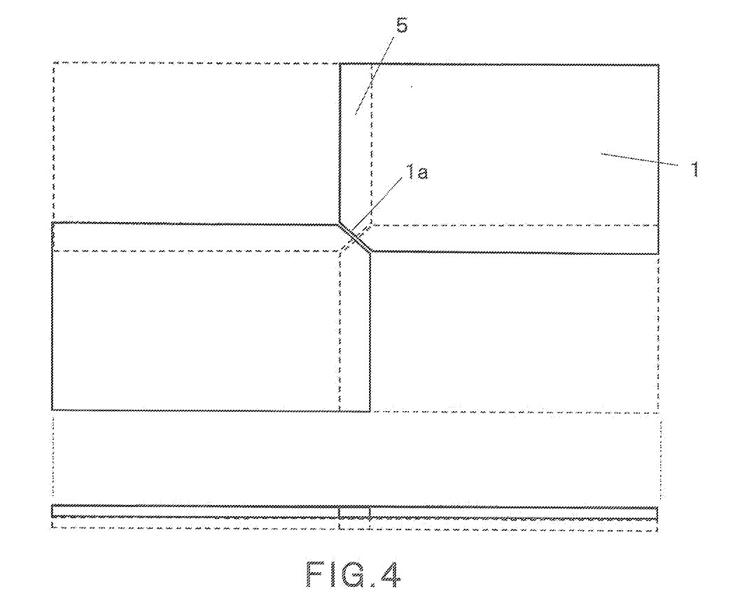

FIG. 4 is a view including a plan view and a sectional view of a flat display 10 according to the present embodiment. The flat display 10 of FIG.4 has four display panels 1 in total that are arranged in such a manner that two panels are arranged adjacent to each other in a vertical direction and the other two panels are arranged adjacent to each other in a horizontal direction. The two display panels 1 adjacent to each other in the horizontal direction are arranged in such a manner that the non-display parts 5 of the two display panels 1 are at least partially overlapped with each other vertically. Likewise, the two display panels 1 adjacent to each other in the vertical direction are arranged in such a manner that the non-display parts 5 of the two display panels 1 are at least partially overlapped with each other vertically. Here, the wording “vertically” means “front and behind” for a viewer positioned in front of the flat display 10.

In the case where the display panel 1 is a rectangular panel such as in FIG. 1, as shown in FIG. 2, when the non-display parts 5 of two display panels 1 are disposed to overlapped with each other in the vertical and horizontal directions, the four display panels 1 interfere with each other at the center area of the flat display 10. Thus, a two-step structure cannot be achieved. For this reason, in FIG. 4, a cut-away cross section formed by cutting away one corner part 1a of each display panel 1 is placed to be in contact with another cut-away cross section of a diagonally arranged display panel 1. With this arrangement, a display panel 1 does not interfere with another display panel 1 when the non-display parts 5 of two display panels 1 are disposed to overlap with each other in each of the vertical and horizontal directions. In more detail, in the case of FIG. 4, since two display panels 1 are arranged in the same step in an oblique, or diagonal direction, the cut-away cross sections of these display panels 1 are placed in contact with each other.

FIG. 4 shows an example of arrangement in which two display panels 1 indicated by solid lines are arranged in the upper step and two display panels 1 indicated by broken lines are arranged in the lower step. However, it is possible to arrange the two display panels 1 indicated by the solid lines in the lower step and the two display panels 1 indicated by the broken lines in the upper step.

As described above, in FIG. 4, the two display panels 1 arranged in the upper step are supported by the two display panels 1 diagonally arranged in the lower step, thus being structurally stable. Moreover, since the non-display parts 5 are placed overlapping each other, the ratio of the area of the non-display parts 5 to the area of the display parts 4 of the flat display 10 is lowered. Thus, the non-display parts 5 are less noticeable, thereby improving the display quality.

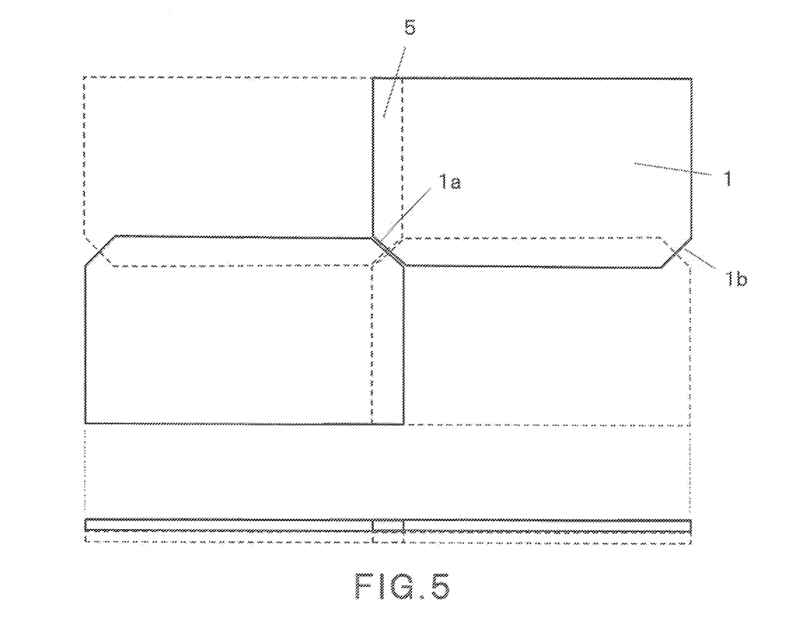

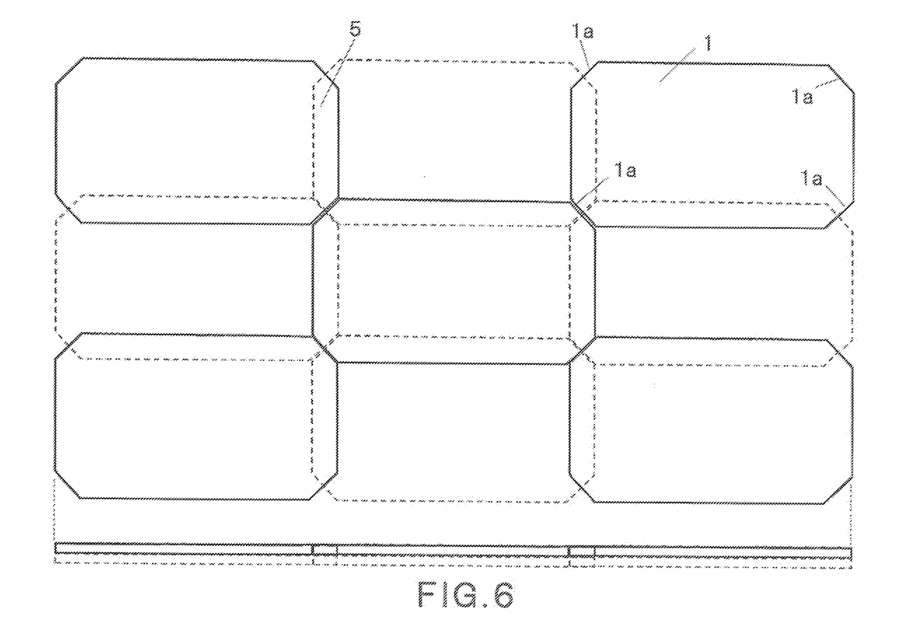

FIG. 5 is a plan view and a sectional view of a flat display 10 according to one modification to FIG. 4. In FIG. 5, two corner parts 1a of each display panel 1 in a longitudinal direction are cut away. The two cut-away corner parts 1a are visible as concaves 1b at the center areas on both edges of the flat display 10 in the longitudinal direction. However, since the concaves 1b are located in the non-display parts 5, display quality is not affected. In the case of FIG. 5, since two corner parts 1a of each display panel 1 in the longitudinal direction are cut away, three or more display panels 1 can be arranged adjacent to one another in the horizontal direction of a flat display 10. Thus, in the case of FIG. 5, it is possible to make a wider flat display 10 than in the case of FIG. 4.

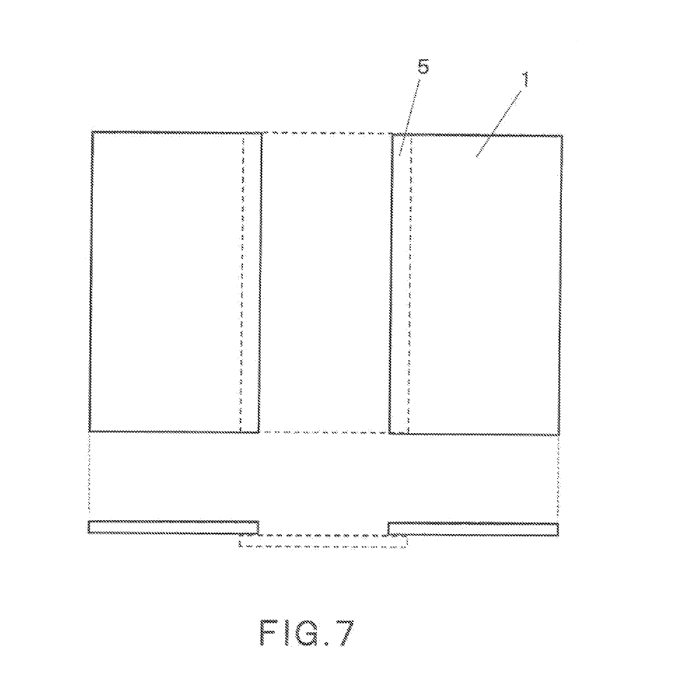

In order to arrange three or more display panels 1 adjacent to one another also in the vertical direction, for example, as shown in FIG. 6, four corner parts 1a of each display panel 1 may be cut away. FIG. 6 is a view including a plan view and a sectional view of a flat display 10 having three display panels 1 arranged in the vertical and horizontal directions. With four cut-away corner parts 1a for each display panel 1, there is no limitation to the number of display panels 1 to be arranged adjacent to one another in the vertical and horizontal directions.

As described above, the flat display 10 according to the present embodiment has no particular limitation to the number of display panels 1 to be used. In addition, there is no particular limitation to the ratio of the number of display panels 1 to be arranged in the vertical direction to the number of display panels 1 to be arranged in the horizontal direction.

FIGS. 4 to 6 show examples of arrangement of display panels 1 in which at least two display panels 1 are adjacently arranged in the vertical and also horizontal directions. However, a plurality of display panels 1 may be arranged in the vertical direction only or in the horizontal direction only.

For example, FIG. 7 is a view including a plan view and a sectional view of a flat display 10 having three display panels 1 arranged adjacent to one another in the horizontal direction. In the example of FIG. 7, among the three display panels 1 arranged in the horizontal direction, the center display panel 1 is disposed in the lower step and two display panels 1 on both sides are disposed in the upper step in such a manner that at least portions of non-display parts 5 are overlapped with each other. In FIG. 7, two display panels 1 on both sides are disposed in the upper step, hence structurally unstable. It is therefore required to provide a support substrate or the like around the two display panels 1. In an opposite way to the arrangement of FIG. 7, it is possible to dispose the center display panel 1 in the upper step and the two display panels 1 on both sides in the lower step. With this arrangement, a more stable structure than that of FIG. 7 is achieved.

In the flat display 10 of FIG. 7, since the part of a non-display part 5 along one edge of a display panel 1 is only overlapped with the part of another non-display part 5 along one edge of another display panel 1, the corner parts of each display panel 1 are not required to be cut away.

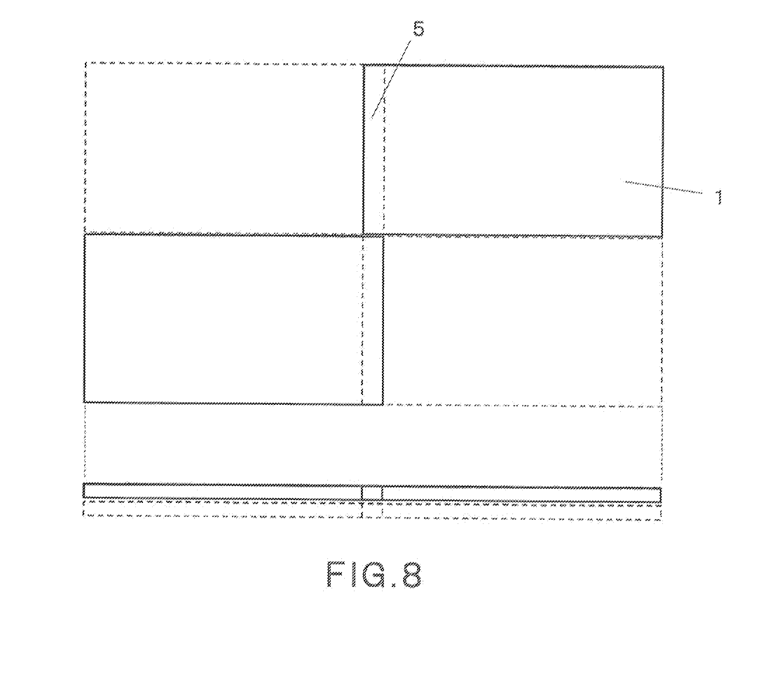

FIG. 8 is a view including a plan view and a sectional view of a flat display 10 according to one modification to FIG. 7. FIG. 8 includes a plan view and a sectional view of a flat display 10 having two display panels 1 arranged adjacent to each other in the vertical and also horizontal directions. Like shown in FIG. 7, the flat display 10 of FIG. 8 uses four display panels 1 in total having no corner parts 1a cut away. Among the four display panels 1, for example, the diagonally arranged two display panels 1 indicated by solid lines are disposed in the lower step and the diagonally arranged two display panels 1 indicated by broken lines are disposed in the upper step. The two display panels 1 adjacent in the vertical direction are in contact with each other at their edges with no overlapping between the non-display parts 5. In other words, in the flat display 10 of FIG. 8, the non-display parts 5 are overlapped with each other only for the two display panels 1 arranged adjacent to each other in the horizontal direction. Therefore, the size of the non-display parts 5 cannot be effectively reduced for the flat display 10 in the vertical direction.

FIGS. 4 to 8 show the flat display 10 merely as an example. There is no limitation to how the display panels 1 are arranged as long as the non-display parts 5 are at least partially overlapped with each other for at least two display panels 1.

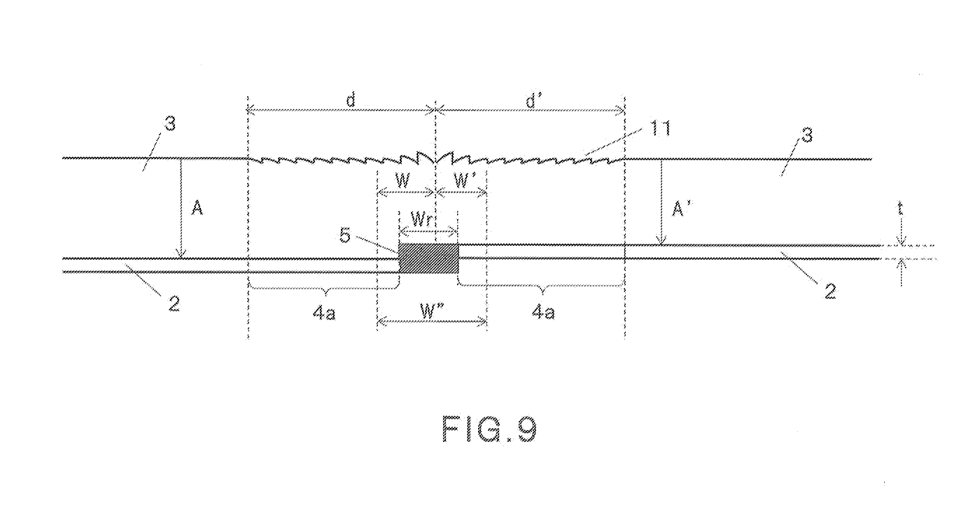

FIG. 9 is a sectional view of two non-display parts 5 overlapped with each other and the area around the two non-display parts 5. The non-display parts 5 are overlapped with each other by a width Wr of two display panels 1 arranged adjacent to each other. The regions having widths W and W′, respectively, are the regions that cannot be seen when a viewer views a flat display 10 through a magnifying optical part 11 from the direction of the normal to the display screen. The total width of W and W′ is W″. The thickness of a transparent member 3 of one display panel 1, the thickness of a transparent member 3 of the other display panel 1, and the thickness of both display panels 1 are denoted by A, A′, and t, respectively.

As shown in FIG. 9, a transparent member 3 of each display panel 1 has a magnifying optical part 11. The magnifying optical part 11 is disposed to cover the region in the range from the border line between a non-display part 5 and a display part 4 to a display area 4a that is part of the display part 4. An image displayed in the display area 4a is magnified by the magnifying optical part 11.

It is supposed that an image is displayed in the display area 4a in the same scale as images displayed in the other display areas of the display part 4. In this case, the image displayed in the display area 4a is visually perceived by a viewer as magnified further by the magnifying optical part 11. This causes a difference in scale between the magnified image and other images which are seen without passing through the magnifying optical part 11. For this reason, it is required to set a smaller scale for an image to be displayed in the display area 4a than images to be displayed in the other display areas.

In FIG. 9, the magnifying optical parts 11 of two transparent members 3 arranged adjacent to each other are disposed in regions at specific distances d and d′, respectively, from the edges of the transparent members 3.

As shown in FIG. 9, each magnifying optical part 11 is integrally formed on the surface of the corresponding the transparent member 3. The magnifying optical part 11 magnifies an image displayed on part of the display part 4 of the image-forming substrate 2 to display a magnified image. Therefore, a minimum requirement for the magnifying optical part 11 is optical characteristics like a convex lens. Nevertheless, a display area of the magnifying optical part 11 through which an image is magnified when displayed covers the entire length of the border line between the non-display part 5 and the display part 4. It is therefore required to use a cylindrical lens for the magnifying optical part 11 to have optical characteristics like a convex lens for such a wide area. Cylindrical lenses show different optical-image magnifying ratios by adjusting the curvature. Cylindrical lenses usually have a semicylindrical shape. However, in this embodiment, since the transparent member 3 is required to be formed as thin as possible, what is shown in FIG. 9 is an example of the magnifying optical part 11 made of a linear Fresnel lens that has optical characteristics like a convex lens. Linear Fresnel lenses have lens pieces, of a cylindrical lens sliced in the longitudinal direction, aligned on a horizontal plane. Linear Fresnel lens can be formed thinner than a usual cylindrical lenses.

The magnifying optical part 11 of FIG. 9 is disposed to surround the display part 4 located in the center area of the rectangular display panel 1 shown in FIG. 1, having linear Fresnel lenses extending in four directions and connected continuously.

In FIG. 9, linear Fresnel lenses provided to the two display panels 1 arranged adjacent to each other are connected with no level differences therebetween. Since these two display panel 1 have non-display parts 5 overlapped with each other vertically, the display panels 1 have a level difference therebetween. Therefore, if the transparent members 3 of the display panels 1 have the same thickness, there must be a level difference on the surfaces of the transparent members 3, that is, on the surfaces of the linear Fresnel lenses. In order to dispose two linear Fresnel lenses adjacent to each other with no level differences between their surfaces, the linear Fresnel lenses may be formed to have different thicknesses, for example. However, if the linear Fresnel lenses have different thicknesses, there is a difference in the distance from the linear Fresnel lenses to the display panels 1. It is therefore required to adjust either the focal lengths of the linear Fresnel lenses or the size of images displayed in the display areas 4a so that there is no difference in size of images seen by a viewer through the linear Fresnel lenses.

In the case of adjusting the focal lengths of the linear Fresnel lenses, the focal length of a linear Fresnel lens located far from the display panels 1 may be adjusted to be longer while the focal length of a linear Fresnel lens located near to the display panels 1 may be adjusted to be shorter. It is also possible to form the two linear Fresnel lenses to have the same focal length and thickness, and shift the border line between the linear Fresnel lenses in left and right to optically compensate the level difference therebetween, with the viewing area symmetrical in left and right. In this case, the border line between the two linear Fresnel lenses may be shifted toward the linear Fresnel lens closer to the display panels 1.

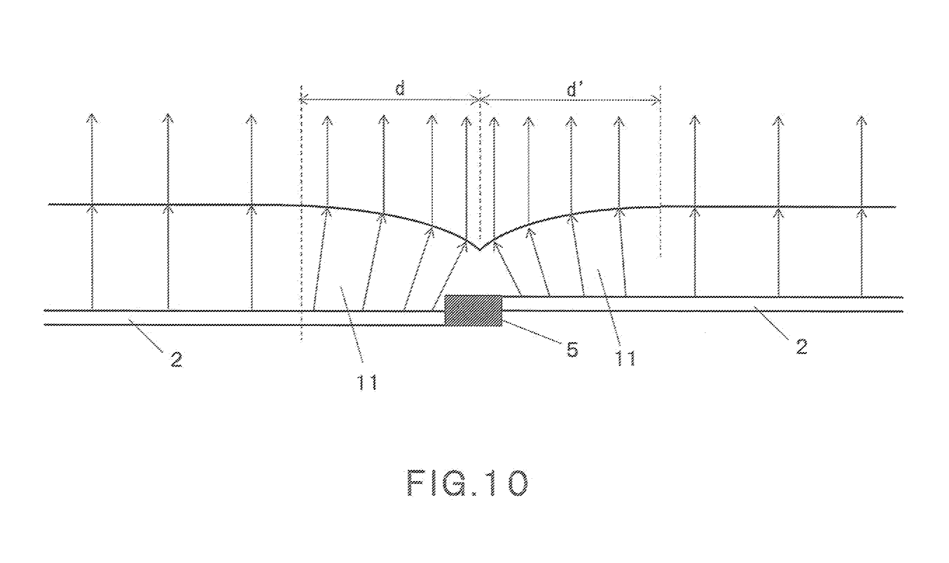

FIG. 10 is an enlarged sectional view of a flat display 10 having magnifying optical parts 11 made of a cylindrical lens instead of a linear Fresnel lens. Since a linear Fresnel lens has the same optical characteristics as a cylindrical lens, the travel directions of light beams from image-forming substrates 2 will be explained with reference to FIG. 10.

As shown in FIG. 10, magnifying optical parts 11 of two transparent members 3 arranged adjacent to each other are disposed in a range of specific distances d and d′, respectively, from the edges of the transparent members 3. The magnifying optical parts 11 bend light beams in such a manner that, as being closer to the edges of the transparent members 3, light beams emitted in the direction of normal to the display screen of the flat display 10 and light beams emitted from the image-forming substrates 2 form a bigger angle. Therefore, an image closer to the non-display part 5 is displayed on the display part 4 at a location shifted closer to the edge from an original location. Moreover, an enlarged image from the display part 4 is displayed in front of the region where the non-display parts 5 are overlapped with each other. It is therefore hard to notice the non-display part 5, and hence the non-display part 5 is apparently invisible. As described, the magnifying optical parts 11 magnify images displayed on the display parts 4 which are located closer to the non-display parts 5, so that the non-display parts 5 are invisible for a viewer.

However, the non-display part 5 is invisible when a viewer views the flat display 10 within the range of a specific angle (for example, ±10°) from a normal direction to the display surface of the flat display 10. When a viewer views the flat display 10 out of this range, at least part of the non-display parts 5 would be visible.

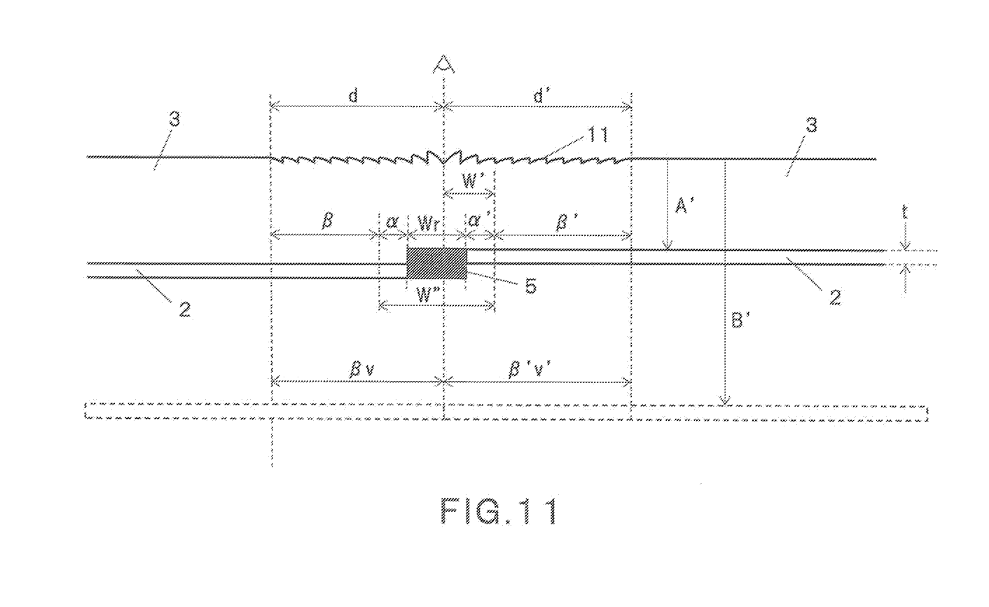

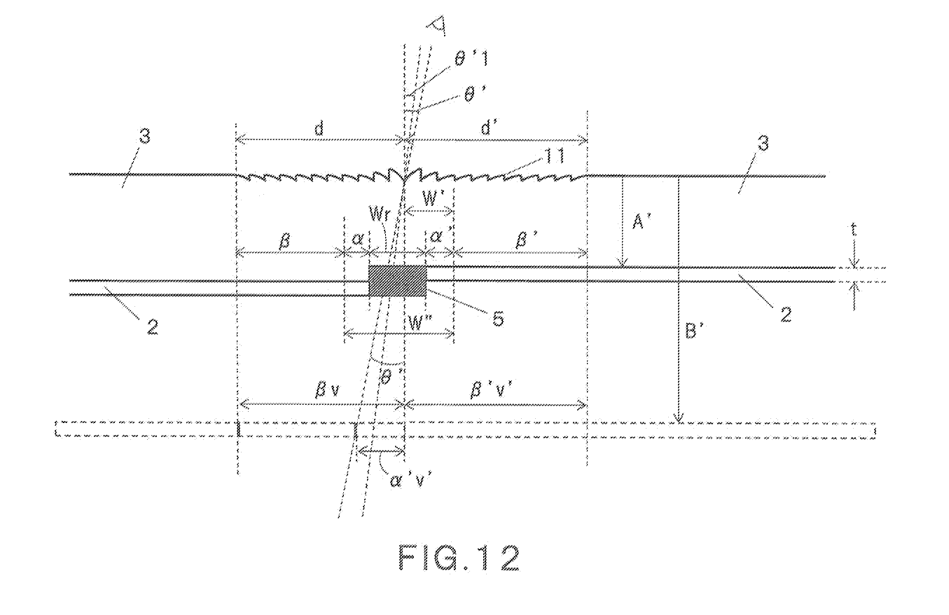

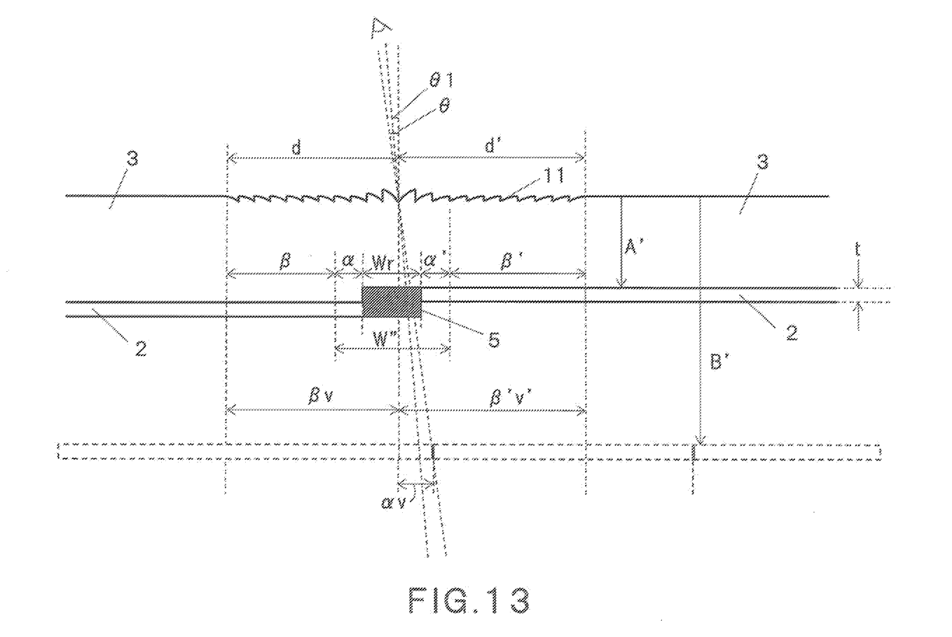

FIG. 11 is a view illustrating a virtual image in the case where a viewer views the flat display 10 from the direction of normal to the display screen. FIG. 12 is a view illustrating a virtual image in the case where when a viewer views the flat display 10 from an obliquely left direction. FIG. 13 is a view illustrating a virtual image in the case where a viewer views the display screen from an obliquely right direction. The obliquely left direction is a viewer's viewing direction that is the obliquely right direction in FIG. 12. The virtual image is an image that is visually perceived by a viewer when the viewer views the flat display 10 through the magnifying optical parts 11.

In the case of FIG. 11, among the light beams that have passed through the magnifying optical part 11 of the left-side display panel 1, the light beams that have passed through the region in the range from the border between the display part 4 and the non-display part 5 to α toward the display part 4 inside the left-side display panel 1 are visible as a virtual image. In FIG. 11, the magnifying optical part 11 of the left-side display panel 1 is adjusted to have an image magnification ratio v. Thus, a viewer views a virtual image of a region βv to which a region β in the display part 4 is magnified.

Moreover, among the light beams that have passed through the magnifying optical part 11 of the right-side display panel 1, the light beams that have passed through the region in the range from the border between the display part 4 and the non-display part 5 to α′ toward the display part 4 inside the right-side display panel 1 are visible as a virtual image. In FIG. 11, the magnifying optical part 11 of the right-side display panel 1 is adjusted to have an image magnification ratio v′. Thus, a viewer views a virtual image of a region βv′ to which a region β′ in the display part 4 is magnified.

As shown in FIG. 11, a virtual image is formed behind the mage-forming substrate 2. The depth (the distance from the image-forming substrate 2) of a virtual image formed by the magnifying optical part 11 of the left-side display panel 1 mainly depends on the focal length of the magnifying optical part 11. The same is true for a virtual image formed by the magnifying optical part 11 of the right-side display panel 1. It is desirable that the depths of the two virtual images have the same length. It is possible to minimize the difference in depth of the two virtual images by adjusting the focal lengths of the magnifying optical parts 11.

As shown in FIG. 11, when a viewer views the flat display 10 from the position right in front of the flat display 10, a virtual image is visible by the viewer, hence the non-display part 5 is invisible. Also the region α toward the display part 4 from the border between the display part 4 and the non-display part 5 is invisible. It is required to display an image in the range of the region α, which must be seen when a viewer views the flat display 10 from a position shifted from the position right in front of the flat display 10.

As shown in FIG. 12, when a viewer views the flat display 10 from an obliquely left direction, in the right-side display panel 1 in FIG. 12, a virtual image in a range that covers a region around the border between the non-display part 5 and the display part 4 is visible. In more concretely, a virtual image of a region α′v′ is visible, the region α′v′ being a region magnified from a region α′ that is invisible when the viewer views the flat display 10 from the position right in front of the flat display 10. In the left-side display panel 1, a virtual image of part of a region βv is visible, the region βv being a region magnified from a region β of the display part 4, while part of the region β is invisible along with a region α that is invisible when the viewer views the flat display 10 from the position right in front of the flat display 10. When a viewer views the flat display 10 from an obliquely left direction of an angle θ′1, part of a virtual image βv and part of a virtual image α′v′ are visible, with an oblique line corresponding to θ′1 as the border therebetween. When the viewer views the flat display 10 from an obliquely left direction of angle θ′, part of the virtual image βv and the virtual image α′v′ are visible, with an oblique line corresponding to θ′ as the border therebetween. When the viewer views the flat display 10 at an angle larger than the angle θ′ of obliquely left direction, a virtual image of the non-display part 5 is inevitably seen adjacent to the virtual image α′v′. Therefore, a proper viewing angle range is limited up to θ′.

As described above, when a viewer views the flat display 10 from an obliquely left direction, in the right-side display panel 1, a virtual image of a wider range is visible while, in the left-side display panel 1, a virtual image of a narrower range is visible.

As shown in FIG. 13, when a viewer views the flat display 10 from an obliquely right direction, in the left-side display panel 1 in FIG. 13, a virtual image in a range that covers a region around the border between the non-display part 5 and the display part 4 is visible. In more concretely, a virtual image of a region αv is visible, the region αv being a region magnified from a region α that is invisible when the viewer views the flat display 10 from the position right in front of the flat display 10. In the right-side display panel 1, a virtual image of part of a region β′v′ is visible, the region β′v′ being a region to which a region β′ is magnified while part of the region β′ is invisible along with a region α′ that is invisible when the viewer views the flat display 10 from the position right in front of the flat display 10.

As described above, when a viewer views the flat display 10 from an obliquely right direction, in the left-side display panel 1, a virtual image of a wider range is visible while, in the right-side display panel 1, a virtual image of a narrower range is visible. When the viewer views the flat display 10 from an obliquely right direction of angle θ1, part of the virtual image β′v′ and part of the virtual image αv are visible, with an oblique line corresponding to θ1 as the border therebetween. When the viewer views the flat display 10 from an obliquely right direction of angle θ, part of the virtual image β′v′ and the virtual image αv are visible, with an oblique line corresponding to θ as the border therebetween. When the viewer views the flat display 10 at an angle larger than the angle θ of obliquely right direction, a virtual image of the non-display part is inevitably seen adjacent to the virtual image αv. Therefore, a proper viewing angle range is limited up to θ.

As described above, in two display panels 1 arranged adjacent to each other, the level difference may occur between the surfaces of transparent members 3 when non-display parts 5 are overlapped with each other vertically. In order to avoid the level difference, for example, the transparent members 3 to be arranged adjacent to each other may be formed to have different thicknesses. However, this means that a plurality of types of display panel 1 having transparent members 3 of different thicknesses have to be prepared. Such preparation of a plurality of types of display panel 1 causes increase in material costs. It is therefore desirable to use display panels 1 of the same structure.

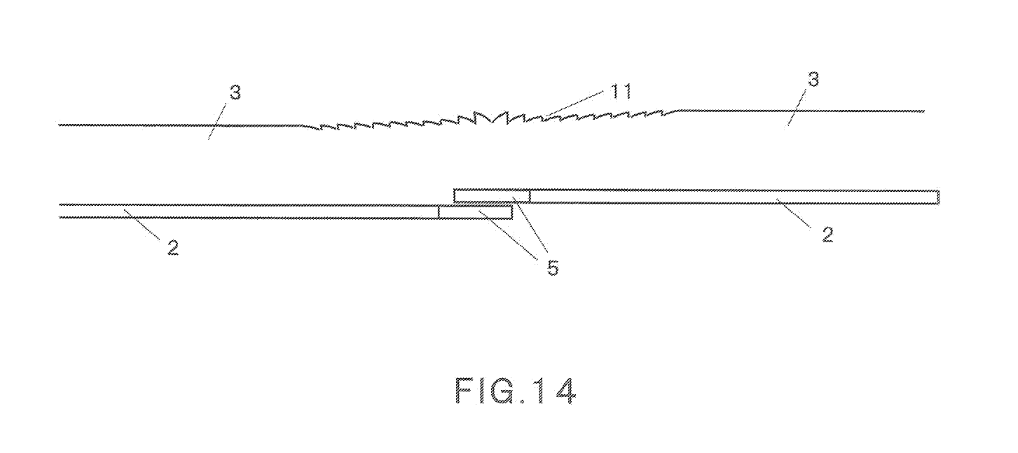

FIG. 14 is a view showing an example using display panels 1 of the same structure, with no level differences between the surfaces of transparent members 3. In FIG. 14, a magnifying optical part 11 of each transparent member 3 has a gently inclined surface. When non-display parts 5 of two display panels 1 are vertically overlapped with each other, the level difference occurs between the surfaces of transparent members 3 of the display panels 1 when the transparent members 3 have the same thickness. However, as shown in FIG. 14, when the two magnifying optical parts 11 are formed to have a gently inclined surface, no level difference occurs and hence the surfaces of two transparent members 3 lie in the same level even if the transparent members 3 have the same thickness.

As described above, when two magnifying optical parts 11 are formed to have a gently inclined surface, two transparent members 3 may have the same thickness. Therefore, the same material can be used and hence the material costs can be reduced.

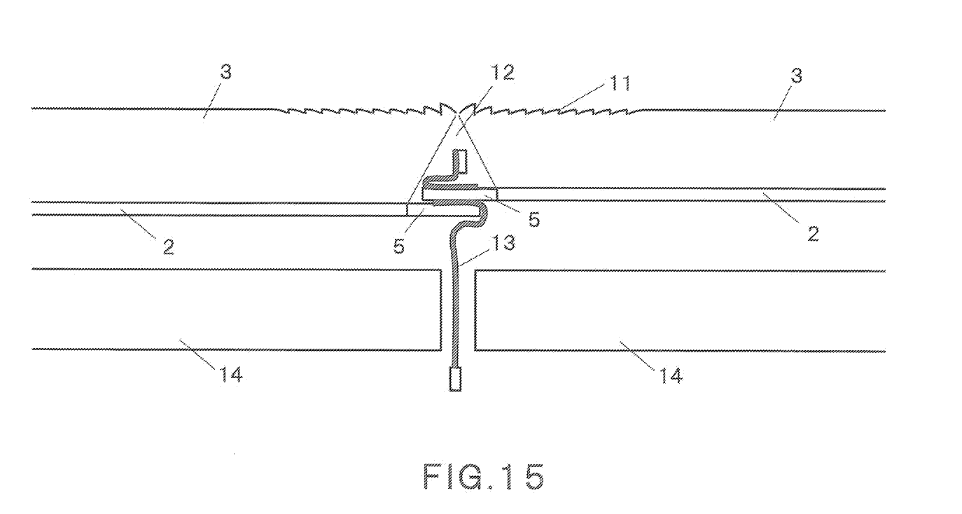

In a conventional display panel 1, it is possible to incorporate a driver IC for driving a display part 4 in a non-display part 5. By contrast, in the present embodiments, since the non-display parts 5 are overlapped with each other, it is required to secure a space for incorporating a driver IC. FIG. 15 is a sectional view showing an example of driver IC incorporation according to the present embodiment. In FIG. 15, similar to FIG. 3, a display panel 1 has an inclined side face. With this arrangement, when two non-display parts 5 are overlapped with each other vertically, a space 12 having a triangle-like cross section is secured between inclined side faces of two display panels 1 arranged adjacent to each other. In FIG. 15, using this space 12, a driver IC, wirings connected to the driver IC such as a flexible wiring board 13, etc. are incorporated or housed. In the example of FIG. 15, an end of a flexible wiring board 13 extends toward the display panels 1, through a gap between non-display parts 5, and is connected to a driver IC. Or, a gap may be provided between plane illumination substrates disposed behind two display panels 1 arranged adjacent to each other, and a flexible wiring board 13 may be provided so as to pass through the gap to connect the flexible wiring board 13 to a driver IC incorporated behind plane illumination substrates.

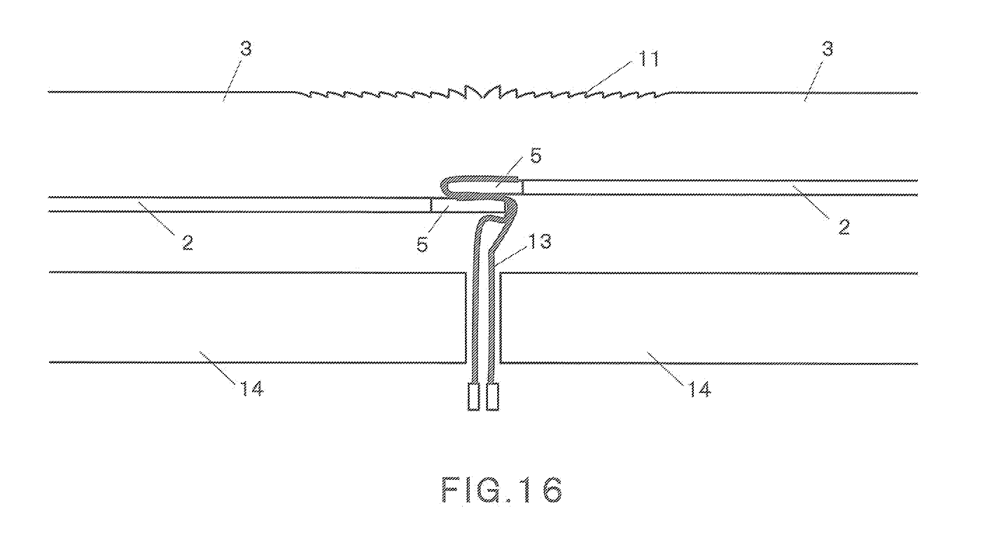

Alternatively, when an image processing substrate is provided separately from display panels 1, as shown in FIG. 16, a flexible wiring board 13 may be bent along non-display parts 5 of two display panels 1 arranged adjacent to each other, and a flexible wiring board 13 may be provided so as to pass through a gap between plane illumination substrates disposed behind the two display panels 1 to connect the flexible wiring board 13 to an image processing substrate (not shown).

As described above, in the present embodiments, since non-display parts 5 of two display panels 1 arranged adjacent to each other are overlapped with each other vertically, the width of the non-display part 5 can be reduced. Moreover, magnifying optical parts 11 are aligned in a horizontal direction when provided on the edges of transparent members 3 disposed on display panels 1. Therefore, the non-display part 5 are invisible when a viewer views the display screen of a flat display 1 within a specific angle range from the normal direction of the display surface on the display panel 1. Especially, in the present embodiments, since the non-display parts 5 are overlapped with each other vertically, an angle range within which the non-display part 5 are invisible can be widened.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A flat panel display device comprising a plurality of display panels arranged adjacent to one another on a display screen,
wherein each display panel comprises:
an image-forming substrate comprising a display part and a non-display part disposed around the display part; and
a transparent member disposed on the image-forming substrate so as to cover the display part and the non-display part,
among the display panels, two adjacent display panels are arranged in a manner that non-display parts of the two adjacent display panels are at least partially overlapped with each other, and
the transparent member of each of the two adjacent display panels comprises a magnifying optical part to magnify an image displayed in a partial display area in the display part from a border between the display part and the non-display part toward the display part.

2. The flat panel display device of claim 1, wherein the magnifying optical part is integrally structured on at least part of an edge of the transparent member.

3. The flat panel display device of claim 1, wherein two magnifying optical parts, each identical with the magnifying optical part, corresponding to the two adjacent display panels are arranged in parallel to a direction of a surface of the image-forming substrate.

4. The flat panel display device of claim 1, wherein two magnifying optical parts, each identical with the magnifying optical part, corresponding to the two adjacent display panels are arranged obliquely from a direction of a surface of the image-forming substrate.

5. The flat panel display device of claim 2, wherein the magnifying optical part is a cylindrical lens structured integrally with the transparent member.

6. The flat panel display device of claim 2, wherein the magnifying optical part is a linear Fresnel lens formed integrally with the transparent member.

7. The flat panel display device of claim 1, wherein a focal position of the magnifying optical part is set according to a thickness of the transparent member.

8. The flat panel display device of claim 7, wherein the focal position of the magnifying optical part is set so that the non-display part of each adjacent display panel is invisible and so that part of an image displayed in the display part adjacent to the non-display part is visible when the display panels are viewed within a specific angle range from a normal direction to the magnifying optical part.

9. The flat panel display device of claim 1, wherein each display panel is a rectangular panel having four non-display parts, each disposed along each side of the rectangular panel, and
among four of the display panels, two display panels are arranged adjacent to each other in a first direction and the other two display panels are arranged adjacent to each other in a second direction orthogonal to the first direction, non-display parts of the two display panels arranged adjacent to each other in the first direction are overlapped with each other and non-display parts of the other two display panels arranged adjacent to each other in the second direction are overlapped with each other.

10. The flat panel display device of claim 9, wherein each of the four display panels comprises four corner parts and at least one of the corner parts has a cut cross section cut obliquely so as to match a size of the non-display part, and
among the four of the display panels, two display panels diagonally arranged are disposed in an upper step with the cut cross sections being in contact with each other and the remaining two display panels diagonally arranged are disposed in a lower step with the cut cross sections being in contact with each other.

11. The flat panel display device of claim 1, wherein each display panel has a rectangular panel having four non-display parts, each disposed along each side of the rectangular panel, and
among four of the display panels, two display panels are arranged adjacent to each other in a first direction and the other two display panels are arranged adjacent to each other in a second direction orthogonal to the first direction, non-display parts of the two display panels arranged adjacent to each other in the first direction are overlapped with each other and non-display parts of the other two display panels arranged adjacent to each other in the second direction are disposed without being overlapped with each other.
